(19) United States
(12) Patent Application Publication
(10) Pub. No.: US 2026/0189488 A1
(43) Pub. Date: Jul. 2, 2026

(54) System and Method for Monitoring Traffic and Activity Using a Mesh Network

(71) Applicant: Sloan Valve Company, Franklin Park, IL (US)

(72) Inventor: Kay Herbert, Winthrop, MA (US)

(21) Appl. No.: 19/439,049

(22) Filed: Jan. 2, 2026

Related U.S. Application Data
(60) Provisional application No. 63/741,249, filed on Jan. 2, 2025.

(51) Int. Cl. H04L 43/0817; H04L 41/12; H04L 67/12; H04L 67/75

(52) U.S. Cl. CPC H04L 43/0817; H04L 41/12; H04L 67/12; H04L 67/75

(57) ABSTRACT

Techniques for determining and monitoring traffic and activity in enclosed spaces disclosed herein. The techniques described herein may use a plurality of sensors, installed at random locations and/or positions in the enclosed space, to detect one or more persons in a radius of interest of each sensor. Additionally, other appliances, such as plumbing fixtures, may be used to detect whether a user is present. The plurality of sensors and other appliance-based sensors may form a mesh network. By creating a mesh network, each of the sensors may learn its relative position to other sensors and other appliances. After a threshold number of user events, the system may able to report levels of activity of the enclosed space, such as identifying and predicting load, traffic, occupancy of stalls/fixtures, wait times, dirty/neglected fixtures and level of consumables, etc. In some instances. The system may comprise display the levels of activity via a billboard and/or a dashboard.

### CROSS-REFERENCE TO RELATED APPLICATIONS

This application is a non-provisional of, and claims priority to, U.S. Provisional Application No. 63/741,249, filed on January 2, 2025 and entitled “System and Method for Monitoring Traffic and Activity using a Mesh Network,” the entirety of which is incorporated herein in its entirety for all purposes.

### FIELD OF THE INVENTION

Aspects of the disclosure generally relate to monitoring traffic and activity using a mesh network.

### BACKGROUND OF THE INVENTION

Systems to detect and measure occupancy in enclosed spaces without the use of cameras and/or video cameras are, oftentimes, unreliable. Privacy in certain enclosed spaces, such as restrooms and nursing rooms, prohibits the use of cameras and/or video cameras. Accordingly, there is a need to monitor traffic and activity without the use of cameras and/or video cameras.

### SUMMARY OF THE INVENTION

The following presents a simplified summary of various aspects described herein. This summary is not an extensive overview and is not intended to identify key or critical elements or to delineate the scope of the claims. The following summary merely presents some concepts in a simplified form as an introductory prelude to the more detailed description provided below. Corresponding apparatus, systems, methods, and computer-readable media are also within the scope of the disclosure.

The present disclosure describes a system for monitoring traffic and/or activity of enclosed spaces without the use of cameras and/or video cameras. The present disclosure may resolve real- time uncertainties surrounding customer activities in enclosed spaces, such as commercial bathrooms where camera and/or video surveillance is not feasible. The activity monitoring system described herein may comprise a plurality of sensors. Each sensor may be configured to send information to a computing device when the sensor detects the presence of a human and/or activity (e.g., toilet flush, urinal flush, faucet activation, faucet deactivation, etc.). Any activation or deactivation on a sensor or device may be considered a state change in the enclosed space. Observed sequential state changes may indicate that sensors and/or devices are proximate to one another. This allows the system to learn the relative location of each of the sensors and/or devices. Once the activity monitoring system has determined an activity graph that mimics each device’s relative location in the enclosed space, the activity monitoring system may monitor the enclosed space to inform users of the status of the enclosed space (e.g., occupied stalls, unusable fixture, etc.) and/or redirect the users to alternative locations.

The features, along with many others, and benefits are discussed in greater detail below.

### BRIEF DESCRIPTION OF DRAWINGS

The present disclosure is described by way of example and not limited in the accompanying figures in which:

FIG. 1A shows a monitoring system in accordance with one or more aspects of the disclosure;

FIG. 1B shows an example of an activity graph in accordance with one or more aspects of the disclosure;

FIG. 2 shows an example of a computing device in accordance with one or more aspects of the disclosure;

FIG. 3 shows an example process for traffic and activity monitoring in accordance with one or more aspects of the disclosure.

### DETAILED DESCRIPTION OF THE INVENTION

In the following description of the various example embodiments, reference is made to the accompanying drawings, which form a part hereof, and in which is shown by way of illustration various example embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

Typical Internet-of-Things (IoT) systems may identify certain activities (e.g., frequency of uses, validate proper functionality of appliances/fixtures, etc.) for building management systems. However, IoT systems cannot determine other datapoints, such as level of traffic, wait lines, etc., associated with enclosed spaces. In particular, IoT systems cannot determine a length of time that a person stays in a restroom before and after using a fixture and/or appliance (e.g., faucet, hand dryer, etc.). Prolonged bathroom use may be a security concern, for example, when indigent people seek refuge in public restrooms. The present disclosure addresses the problem of resolving real-time uncertainties associated with enclosed spaces where camera and/or video surveillance is not feasible due to privacy concerns.

The present application describes systems and methods for monitoring traffic and activities in enclosed spaces, such as restrooms, without invading the privacy of users through the use of cameras and/or video-based systems. The system uses a plurality of low-resolution sensors, installed at random locations and/or positions in the enclosed space, to detect one or more persons in a radius of interest of each sensor. Additionally, other appliances, such as plumbing fixtures, may be used to detect whether a user is present. In this regard, the plurality of low-resolution sensors and other appliance-based sensors may form a mesh network. By creating a self-organizing mesh network, each of the sensors may learn its relative position to other sensors and other appliances. After a threshold number of user events, the system may be able to report, with certainty, levels of activity of the enclosed space, such as identifying and predicting bathroom load, traffic, occupancy of stalls/fixtures, wait times, dirty/neglected fixtures and level of consumables, etc. In some instances. The system may comprise a display (e.g., a billboard on the outside of the restroom) that indicates the status of the enclosed space (e.g., restroom). Additionally or alternatively, the system may display the status of the enclosed space via a dashboard, an internet gateway, and/or a building management system.

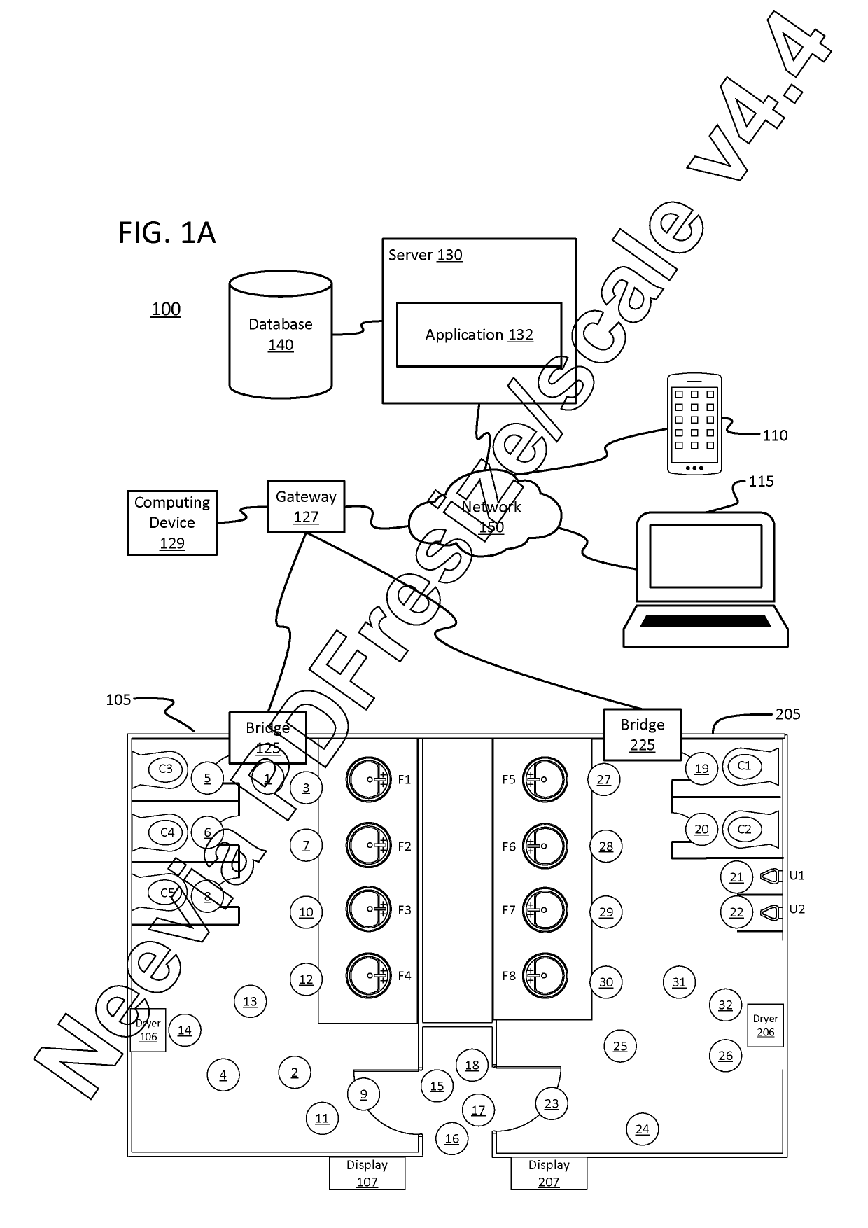

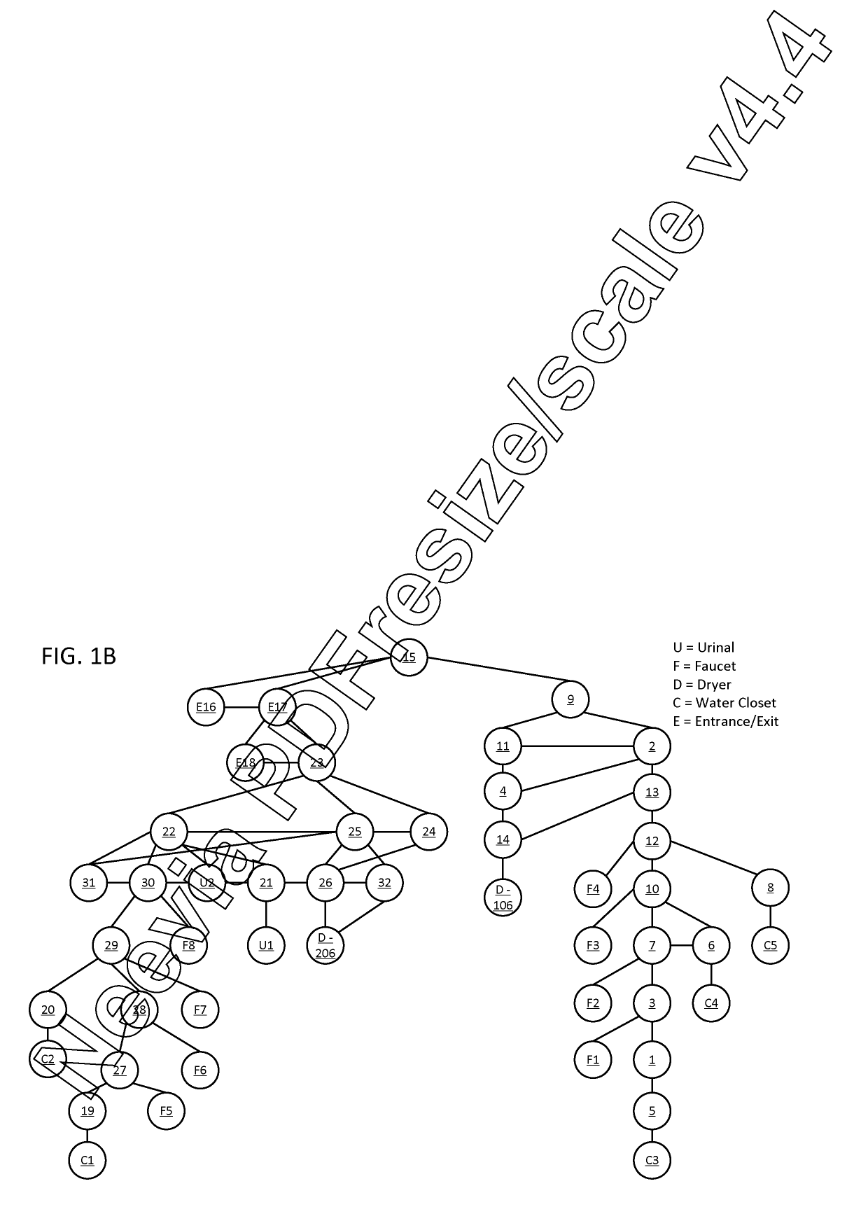

FIG. 1A shows a monitoring system 100 according to one or more aspects of the disclosure is shown. The monitoring system 100 comprises a first (women’s) restroom 105, a second (men’s) restroom 205, a first user device 110, a second user device 115, and a server 130 interconnected via network 150.

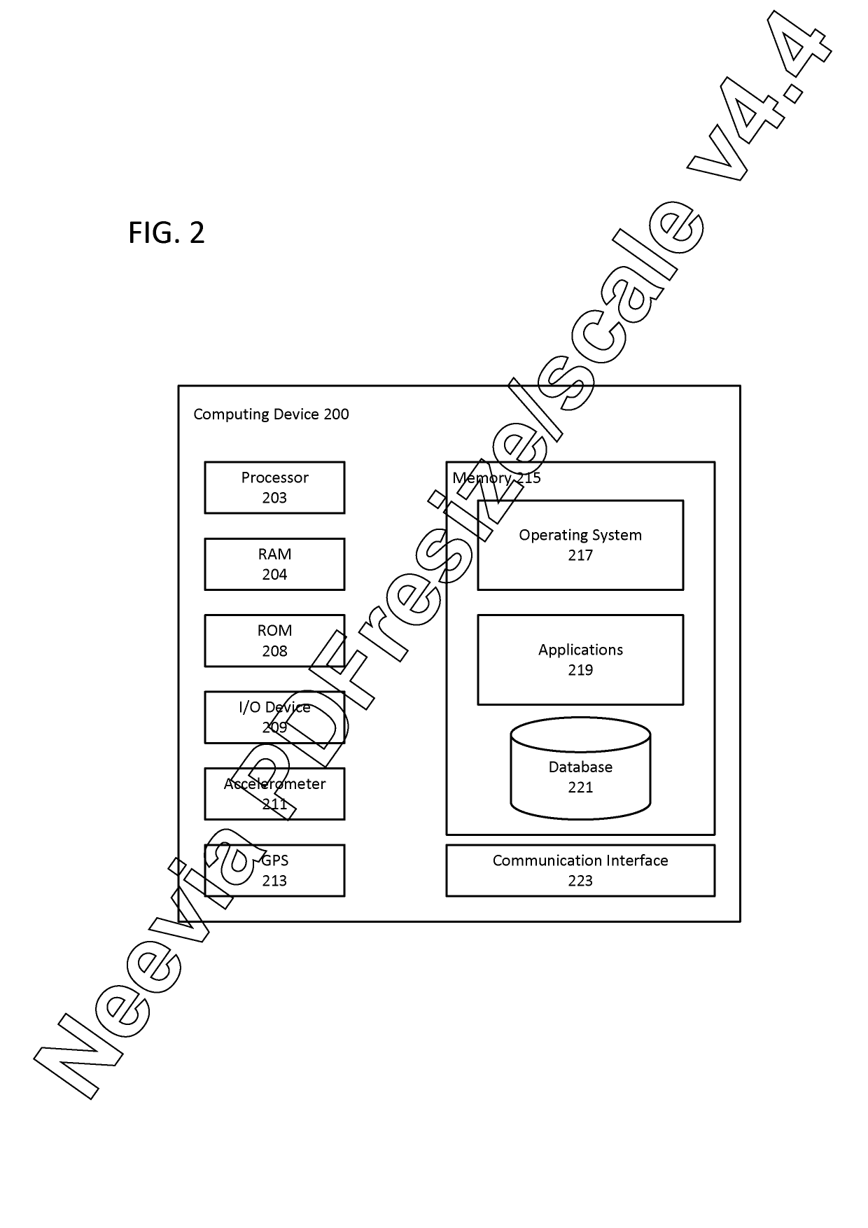

First restroom 105 may be a bathroom in a commercial space, such as an office building, a retailer (e.g., mall), a stadium, etc. First restroom 105 may comprise a plurality of water closets (e.g., C3, C4, C5), a plurality of sinks (e.g., F1, F2, F3, F4), and one or more hand dryers 106. Although not shown in FIG. 1A, first restroom 105 may also comprise hand sanitation units, paper towel dispensers, air fresheners, etc. Further to FIG. 1A, first restroom 105 may comprise a first plurality of sensors (e.g., 1, 2, 3, 4, 5, 6, 7, 8, 9, 10, 11, 12, 13, and 14). The first plurality of sensors may comprise low resolution sensors installed at random positions. The first plurality of sensors may be configured to detect one or more people in a radius of interest of each sensor. According to some aspects of the disclosure, plumbing fixtures and other appliances may be configured to detect if a user is present. The first plurality of sensors may be human activity or presence sensors configured to detect human activity or the presence of humans based on ultrasonic echo location, capacitance, infrared (IR) reflection, radar, etc. The first plurality of sensors can be installed on the floor of first restroom 105. Preferably, the first plurality of sensors may be installed in a ceiling of first restroom 105 and, preferably, hidden behind ceiling tiles in a manner that is convenient to install, but covers most of the floor space of interest. Alternatively, the first plurality of sensors may be installed on the ceiling of first restroom 105. Each sensor and/or device (e.g., toilet flushometer, urinal flushometer, hand dryer, faucet, etc.) may have a unique identifier built therein. The first plurality of sensors and/or each of the devices may discover (e.g., learn) their relative locations inside first restroom 105. That is, the first plurality of sensors and/or each of the devices may form a self-organizing mesh network, which may be used to create a map of first restroom 105. Accordingly, the exact position of each sensor and/or device need not be recorded, for example, during installation. Moreover, the preferred sensor may be a radar sensor that can be hidden behind ceiling tiles. High resolution sensors, such as cameras, are not preferred since cameras may invade the privacy of bathroom occupants. The first plurality of sensors may be hardwired into a building’s electrical supply or receive power via a low-voltage power supply, such as power-over-ethernet (PoE) or from a transformer located in the restroom 105. Each of the first plurality of sensors may have a field of view. When a user enters the field of view, the sensor may be configured to detect the user. As will be discussed in greater detail with respect to FIG. 2B, the sequence with which sensors detect a user may indicate the user’s intent and/or actions in first restroom 105. Additionally or alternatively, first plurality of sensors may determine when a device has been activated (e.g., a toilet, or urinal, flushed, a sink turned on/off, a hand dryer activated, a paper towel dispenser activated, etc.). The first plurality of sensors may send user information and/or usage information to a computing device, such as local computing device 129 and/or the server 130. The local computing device 129 may be a computing device, such as a server, a user device, a location smart display monitor, or any combination thereof, located on the same premises as the restroom 105. The usage information may be sent to the local computing device 129 via the bridge 125. Additionally or alternatively, the usage information may be sent via bridge 125 and/or gateway 127 to the server 130. In response to receiving the signals from the bridge 125, the computing device (e.g., the local computing device 129 and/or the server 130) may determine information about first restroom 105. The information may include a level of traffic associated with first restroom 105. Additionally, the information may include wait times, average length of time in first restroom 105 before using a fixture/appliance, average length of time in first restroom 105 after using a fixture/appliance, areas that people avoid, fixtures and/or appliances that people avoid, fixtures and/or appliances that people use frequently, etc. Additionally or alternatively, the computing device (e.g., the local computing device 129 and/or the server 130) may send a signal to each of the first plurality of sensors, for example, to reconfigure a respective sensor. By transmitting the usage information to the computing device (e.g., the local computing device 129 and/or the server 130), the computing device (e.g., the local computing device 129 and/or the server 130) may be able to ascertain real-time usage data associated with the restroom 105.

Like first restroom 105, second restroom 205 may be a bathroom in a commercial space. Second restroom 205 may comprise a plurality of water closets (e.g., C1, C2), a plurality of urinals (e.g., U1, U2), a plurality of sinks (e.g., F5, F6, F7, F8), and one or more hand dryers 206. Second restroom 205 may also comprise additional fixtures and/or appliances. Second restroom 105 may comprise a first plurality of sensors (e.g., 19, 20, 21, 22, 23, 24, 25, 26, 27, 28, 29, 30, 31, and 32). Second restroom 205 may communicate with the computing device using the techniques described above. In this regard, second restroom 205 may share the same, or similar, information as the information described above with respect to first restroom 105.

As shown in FIG. 1A, a third plurality of sensors (e.g., 15, 16, 17, 18) may be located outside of first restroom 105 and/or second restroom 205. The third plurality of sensors may be located near an entrance and/or exit of each of the respective restrooms. Accordingly, the third plurality of sensors may be configured to detect users entering and/or leaving each of the respective restrooms.

An important aspect of the present disclosure is that the installation of the plurality of sensors is not complicated. In this regard, typical Internet-of-Thing (IoT) fixture installations require an installer to identify the location of the device (e.g., the bathroom location and the location of the sensor inside the bathroom). By identifying the location of the device, maintenance personnel is able to quickly identify a fixture or appliance. The present disclosure greatly simplifies the installation process by eliminating the requirement of an installer identifying the location of a sensor and/or device. As noted above, the self-organizing mesh of sensors and devices discovers their relative locations inside each enclosed space (e.g., bathroom), which may then be mapped out. This allows sensors to be installed in the floor or, more preferably, the ceiling (e.g., behind ceiling tiles) in a manner that is convenient to install, while still covering most of the floor space of interest. The exact positions of each sensor (and plumbing devices) does not needed to be recorded. Each sensor and device (e.g., plumbing fixture) may have a unique identifier (e.g., serial number) built in. The self-organizing mesh network of sensors and/or devices may allow the sensors and/or devices to be positioned in places that allow the installer to avoid inconvenient positions, such as lighting fixtures and vents.

Upon initial activation, the first plurality of sensors, the second plurality of sensors, and/or the third plurality of sensors may detect and/or communicate with other sensors using any short-range wireless protocol, such as Bluetooth, Zigbee, Z-Wave, ANT, LoRa, or any equivalent thereof. Through the initial communications, the first plurality of sensors, the second plurality of sensors, and/or the third plurality of sensors may organize into a first mesh network, a second mesh network, and/or a third mesh network. The first plurality of sensors may be used to generate (e.g., create) a first map of first restroom 105, while the second plurality of sensors may be used to generate (e.g., create) a second map of second restroom 205.

As noted above, the first plurality of sensors, the second plurality of sensors, and/or the third plurality of sensors may communicate (e.g., send, transmit) information about each respective restroom to a computing device, such as the local computing device 129, the server 130, and/or a smart display monitor. The information may be sent via bridge 125 and/or gateway 127. The computing device (e.g., the local computing device 129 and/or the server 130) may send a signal to the first restroom 105, for example -- through the bridge 125 and/or the gateway 127, indicating an occupancy level associated with first restroom 105. First restroom 105 may display the occupancy information, for example, via a first display 107. Second restroom 205 may display similar information via second display 207.

First display 107 and/or second display 207 (collectively, “the displays”) may comprise a liquid crystal display (LCD) display technology, a light emitting diode (LED) display technology, vacuum florescent display technology, and/or the like. The displays may be configured to display information associated with their respective restroom. The information may be received (e.g., provided) from the local computing device 129. Additionally or alternatively, the information may be provided by the server 130 via the gateway 127 and/or first bridge 125 or second bridge 225.

First bridge 125 and/or second bridge 225 (collectively, “the bridges”) may be configured to connect one or more fixtures and/or the plurality of sensors to a network. The network may be a local area network, such as a building or corporate network (e.g., BACNET). The bridges may be wired or wireless bridges. In preferred embodiments, the bridges comprise a wireless interface to communicate (e.g., send/receive) with one or more fixtures and/or the plurality of sensors. The wireless interface may use a short-range wireless communication protocol, such as Bluetooth® communications, Bluetooth® Low Energy communications, Wi-Fi communications, ANT communications, LoRa communications, Zig Bee Communications, or any equivalent thereof.

Gateway 127 may be configured to connect the network (e.g., building or corporate network) to a wide area network, such as network 150. The gateway 127 may provide interoperability between building or corporate network and network 150. The gateway 127 may comprise protocol translators, impedance matchers, rate converters, fault isolators, or signal translators. In some examples, the gateway 127 may perform protocol conversions to connect networks with different network protocol technologies.

First user device 110 may be a mobile device, such as a cellular phone, a mobile phone, a smart phone, a tablet, a laptop, or an equivalent thereof. First user device 110 may provide a first user with access to various applications and services. For example, first user device 110 may provide the first user with access to the Internet. Additionally, first user device 110 may provide the first user with one or more applications (“apps”) located thereon. The one or more applications may provide the first user with a plurality of tools and access to a variety of services. In some embodiments, the one or more applications may include an application that provides access to a dashboard, or portal, that provides information about first restroom 105 and/or second restroom 205. To expand on the information discussed above, the information may include usage and/or statistics about a restroom’s usage. The information may also comprise critical diagnostics. Additionally or alternatively, the information may include information about individual fixtures, including, for example, real-time information about whether a fixture is currently being used. The application may comprise an authentication process to verify (e.g., authenticate) the identity of the first user prior to granting access to the dashboard (e.g., portal) 135.

Second user device 115 may be a device configured to allow a user to execute software for a variety of purposes. Second user device 115 may belong to the first user that accesses first user device 110, or, alternatively, second user device 115 may belong to a second user, different from the first user. Second user device 115 may be a desktop computer, laptop computer, or, alternatively, a virtual computer. The software of second user device 115 may include one or more web browsers that provide access to websites on the Internet. These websites may include plumbing websites that allow the user to view information about a building’s plumbing, an individual bathroom, and/or an individual fixture. In some embodiments, second user device 115 may include an application that allows the user to access a dashboard 135, or portal, to view information about a building’s plumbing, an individual bathroom, and/or an individual fixture. As noted above, the information may comprise critical diagnostics about the restroom. The website and/or the application may comprise an authentication component to verify (e.g., authenticate) the identity of the second user prior to granting access to the dashboard 135 (e.g., portal).

Server 130 may be any server capable of executing application 132. Additionally, server 130 may be communicatively coupled to a database 140. In this regard, server 130 may be a stand-alone server, a corporate server, or a server located in a server farm or cloud-computer environment. According to some examples, server 130 may be a virtual server hosted on hardware capable of supporting a plurality of virtual servers. In some instances, the server 130 may be hosted by a commercial plumbing supply company, such as Sloan Valve Company. The server 130 may be hosted in a cloud provider, such as Microsoft Azure Cloud Service or an equivalent thereof. The server may execute application 132 on behalf of one or more consumers of the products manufactured and distributed by the commercial plumbing supply company.

The application 132 may be server-based software configured to provide users with information about first restroom 105 and/or second restroom 205. In some embodiments, the application 132 may be server-based software that corresponds to client-based software executing on first user device 110 and/or second user device 115. Additionally, or alternatively, the application 132 may provide users access to the information through a website, or portal, accessed by first user device 110 or second user device 115 via network 150. The application 132 may comprise an authentication module to verify users before granting access to the information. The information may include a start time of the fixture’s usage, an end time of the fixture’s usage, a duration of the fixture’s usage, etc. The application 132 may also analyze the information from a plurality of fixtures associated with a location and present the analysis to a user, for example, via the dashboard 135. That is, the application 132 may receive information from each of a plurality of fixtures located in a restroom (e.g., restroom 105). The application 132 may then analyze the information associated with the restroom and present the analysis to a user, via the dashboard 135. The application 132 may provide the analysis with respect to individual restrooms. Additionally or alternatively, the application may provide the analysis for a building, as-a-whole, showing usage and/or statistics for all of the restrooms located in a building. It will be appreciated that the dashboard 135 may allow a user to view usage and/or statistics about the building as-a-whole, while allowing the user to also focus on individual restrooms and/or fixtures. In this regard, the dashboard 135 may provide an overall view of the plumbing of a building, as well as granular data and/or information for individual fixtures. The application 132 may also provide real-time information regarding whether a fixture is currently in use. Further, the dashboard 135 may generate notifications, for example, if a restroom and/or fixture requires attention. The notifications may be an electronic communication, such as an email, a text message, a push notification, etc. Additionally or alternatively, the notifications may be displayed via an alert in the dashboard 135 or location smart display monitor.

The database 140 may be configured to store information on behalf of application 132. The information may include, but is not limited to, data about restrooms, such as the quantity, type, model numbers, etc. of the fixtures associated with a restroom. Additionally or alternatively, the information stored in database 140 may comprise usage and/or statistics of each fixture. User-preferences may also be stored in the database 140. The user-preferences may define how users receive notifications, alerts, etc. The database 140 may include, but is not limited to relational databases, hierarchical databases, distributed databases, in-memory databases, flat file databases, XML databases, NoSQL databases, graph databases, and/or a combination thereof.

Network 150 may include any type of network. In this regard, first network 150 may include the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices in system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in system 100 in front of one or more computing devices such that any external devices may communicate directly with the specialized hardware.

FIG. 1B shows an example of an activity graph in accordance with one or more aspects of the disclosure. In this regard, one or more sensors in a vicinity of a user may be activated, for example, when the user comes in range of the sensor. Each of the one or more sensors may then be deactivated, for example, when the user leaves the sensor range. Accordingly, as one or more users enter and traverse through an enclosed space (e.g., a bathroom), each sensor, of a plurality of sensors, may be activated and, subsequently, deactivated. Any activation, or deactivation, of a sensor or device would be considered a state change. Observed sequential state changes from one sensor to a second sensor/device would indicate that those two devices are "neighbors". On the other hand, when one sensor/device is activated and deactivated, but another sensor/device is not within a reasonable number of system state changes, then those two devices are less likely to be adjacent. One or more computing devices may record the activation of each sensor of the plurality of sensors.

Returning to FIG. 1B, an activity graph in accordance with one or more aspects of the disclosure. As shown by the activity graph, a user may be initially detected before entering first restroom 105 or second restroom 205. The activity graph begins with sensor 15 as the root node. As shown in FIG. 1A, sensor 15 is located outside of first restroom 105 and second restroom 205. Accordingly, sensor 15 may be the first sensor activated when a user uses first restroom 105 or second restroom 205. Continuing down the activity graph, sensor 9 may be activated, for example, when the user is entering (or exiting) first restroom 105. Similarly, sensor 16, sensor 17, and/or sensor 23 may activate when the user is entering (or exiting) second restroom 205. As shown in FIG. 1B, the activity graph illustrates a path of sensors activated between a user entering an enclosed space (e.g., restroom) up to using a particular fixture and/or device. The simplest path shown is between a user entering (e.g., being detected by sensor 15) and walking up to first hand dryer 106. As shown in FIG. 1B, the user may be detected by sensors 15, 9, 11, 4, and 14 before concluding at first hand dryer 106. Although not shown, it will be appreciated that similar activity graphs may be used to illustrate a typical user’s path through the enclosed space, from entering to exit. In this regard, the activity graph may appear diamond shaped.

The activity graph may be generated using machine learning. As noted above, the system comprises a plurality of sensors, fixtures, and other bathroom devices (collectively, “devices” and individually “device”) may be connected to computer via a gateway. Each device may be capable and programmed to send information to the computer, for example, when the device detects a human and/or activity. The information may be sent in real-time. As one or more users enter and traverse through the bathroom to a fixture or device, sensors in the vicinity of each of the users may be activated when the user comes within range of the sensor. The sensor may be deactivated when the user leaves the sensor range. Similarly, fixtures may be activated (e.g., a toilet flush, water turned on in a faucet, etc.), which may trigger a notification to the computer. Any activation or deactivation on a sensor or device may be considered a state change in the respective bathroom. Sequential state changes from a first sensor to a second sensor/device may indicate that those two devices are “neighbors.” On the other hand, when a first sensor (or device) is activated and deactivated, but a second sensor (or device) is not activated within a reasonable number of system state changes, the two devices may be determined to not be adjacent.

An activity monitoring system that based on the established learned mesh estimates the number of people in in the bathroom, what fixtures and devices are in use, which fixtures need maintenance based on attendance, and how many people are waiting to use the fixtures. The one or more machine learning models may be transformer-based models (e.g., sequence-to-sequence (Seq2Seq), etc.) or an equivalent thereof. Additionally or alternatively, the one or more machine learning models may be a neural network, such as a convolutional neural network (CNN), a recurrent neural network, a recursive neural network, a long short-term memory (LSTM), a gated recurrent unit (GRU), an unsupervised pre-trained network, a space invariant artificial neural network, a generative adversarial network (GAN), or a consistent adversarial network (CAN), such as a cyclic generative adversarial network (C-GAN), a deep convolutional GAN (DC-GAN), GAN interpolation (GAN-INT), GAN-CLS, a cyclic-CAN (e.g., C-CAN), or any equivalent thereof. Additionally or alternatively, the one or more machine learning models may comprise one or more decision trees. In some instances, the one or more machine learning models may comprise a Hidden Markov Model. The one or more machine learning models may be trained using supervised learning, unsupervised learning, back propagation, transfer learning, Adam stochastic optimization, stochastic gradient descent, learning rate decay, dropout, max pooling, batch normalization, long short-term memory, skip-gram, or any equivalent deep learning technique. The one or more machine learning models may be trained using self-supervised learning (e.g., contrastive learning) to decouple the embedding spaces of the negative and positive examples. The one or more machine learning models may be trained, for example, using sensor activation data. Specifically, the training data may comprise sensor activation information based on users entering and leaving target areas of the sensors and/or activation of fixtures and appliances. The corpus of sensor activation information may be divided into training data and testing data. Preferably, 65% to 85% of the corpus would form the training data, while the remaining 15% to 35% of the corpus would be test data. The one or more machine learning models may be trained using the training data, while the test data would be used to help the machine learning model achieve convergence (i.e., an error range with an acceptable tolerance). The one or more machine learning models may be trained to identify patterns from the sensor activation information. That is, the one or more machine learning models may perform pattern analysis on the sensor activation information to determine the location of sensors and/or typical usage patterns. Once the one or more machine learning models are trained, the one or more machine learning models may be deployed, for example, as part of an activity monitoring system. The activity monitoring system may estimate, using the one or more trained machine learning models, a number of people in the bathroom, what fixtures and devices are in use, which fixtures need maintenance based on attendance, how many people are waiting to use the fixtures, and the like.

Any of the devices and systems described herein may be implemented, in whole or in part, using one or more computing devices described with respect to FIG. 2. Turning now to FIG. 2, a computing device 200 that may be used with one or more of the computational systems is described. The computing device 200 may comprise a processor 203 for controlling overall operation of the computing device 200 and its associated components, including RAM 204, ROM 208, input/output device 209, accelerometer 211, global-position system antenna 213, memory 215, and/or communication interface 223. A bus 202 may interconnect processor(s) 203, RAM 204, ROM 208, memory 215, I/O device 209, accelerometer 211, global-position system receiver/antenna 213, memory 215, and/or communication interface 223. Computing device 200 may represent, be incorporated in, and/or comprise various devices such as a desktop computer, a computer server, a gateway, a mobile device, such as a laptop computer, a tablet computer, a smart phone, any other types of mobile computing devices, and the like, and/or any other type of data processing device.

Input/output (I/O) device 209 may comprise a microphone, keypad, touch screen, and/or stylus through which a user of the computing device 200 may provide input, and may also comprise one or more of a speaker for providing audio output and a video display device for providing textual, audiovisual, and/or graphical output. Software may be stored within memory 215 to provide instructions to processor 203 allowing computing device 200 to perform various actions. For example, memory 215 may store software used by the computing device 200, such as an operating system 217, application programs 219, and/or an associated internal database 221. The various hardware memory units in memory 215 may comprise volatile and nonvolatile, removable and non-removable media implemented in any method or technology for storage of information such as computer-readable instructions, data structures, program modules, or other data. Memory 215 may comprise one or more physical persistent memory devices and/or one or more non-persistent memory devices. Memory 215 may comprise random access memory (RAM) 204, read only memory (ROM) 208, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Accelerometer 211 may be a sensor configured to measure accelerating forces of computing device 200. Accelerometer 211 may be an electromechanical device. Accelerometer may be used to measure the tilting motion and/or orientation computing device 200, movement of computing device 200, and/or vibrations of computing device 200. The acceleration forces may be transmitted to the processor to process the acceleration forces and determine the state of computing device 200.

GPS receiver/antenna 213 may be configured to receive one or more signals from one or more global positioning satellites to determine a geographic location of computing device 200. The geographic location provided by GPS receiver/antenna 213 may be used for navigation, tracking, and positioning applications. In this regard, the geographic may also include places and routes frequented by the first user.

Communication interface 223 may comprise one or more transceivers, digital signal processors, and/or additional circuitry and software, protocol stack, and/or network stack for communicating via any network, wired or wireless, using any protocol as described herein.

Processor 203 may comprise a single central processing unit (CPU), which may be a single-core or multi-core processor, or may comprise multiple CPUs. Processor(s) 203 and associated components may allow the computing device 200 to execute a series of computer-readable instructions (e.g., instructions stored in RAM 204, ROM 208, memory 215, and/or other memory of computing device 215, and/or in other memory) to perform some or all of the processes described herein. Although not shown in FIG. 2, various elements within memory 215 or other components in computing device 200, may comprise one or more caches, for example, CPU caches used by the processor 203, page caches used by the operating system 217, disk caches of a hard drive, and/or database caches used to cache content from database 221. A CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 204 or on a separate computing device. For example, in a multi-tiered application, a database cache on an application server may reduce data retrieval and data manipulation time by not needing to communicate over a network with a back-end database server. These types of caches and others may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the disclosure.

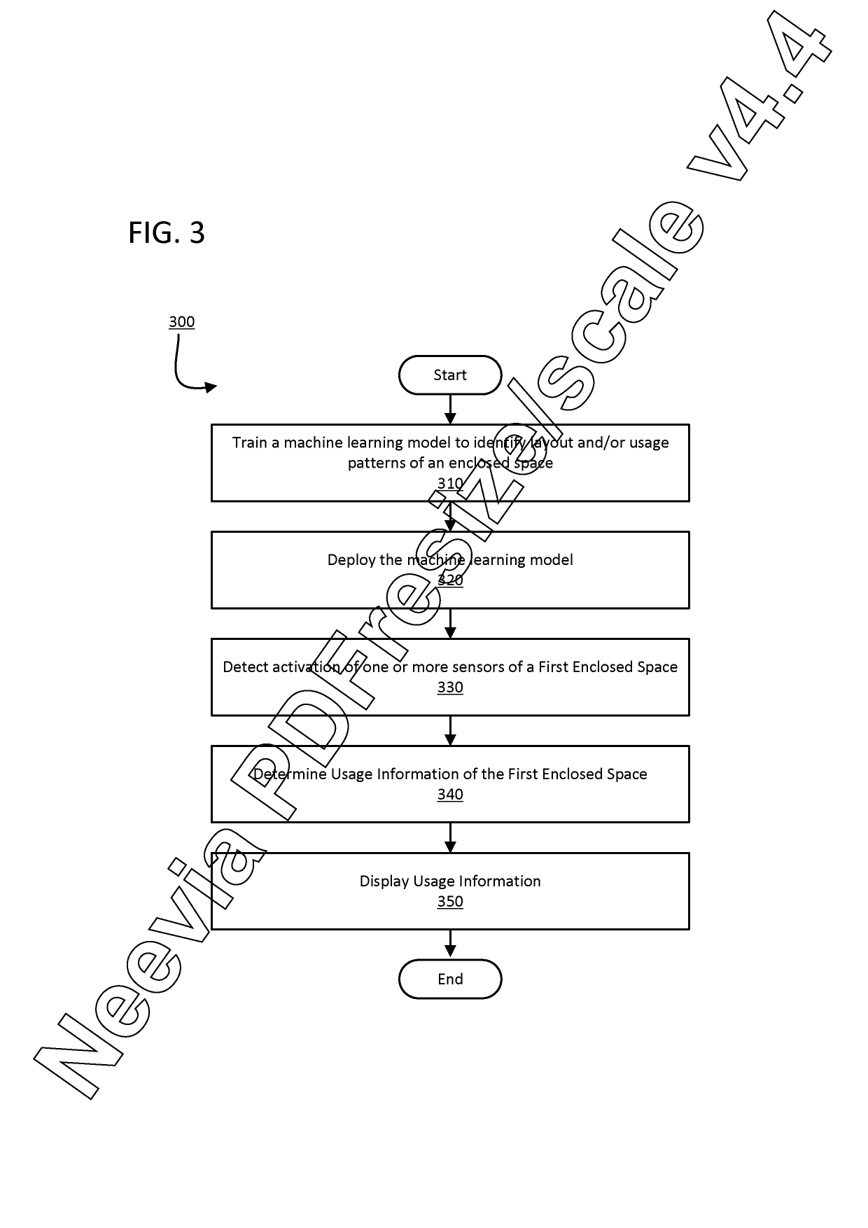

FIG. 3 shows an example of a process 300 for traffic and activity monitoring in accordance with one or more aspects of the disclosure. Some or all of the steps of process 300 may be performed using one or more devices as described herein, including, for example, the devices discussed above with respect to the restroom occupancy system discussed in FIGS. 1A and 1B.

In step 310, a computing device may train one or more machine learning models to identify layout and/or usage patterns of an enclosed space. As noted above, the one or more machine learning models may be transformer-based models (e.g., sequence-to-sequence (Seq2Seq), etc.), neural networks, decision trees, a Hidden Markov Model, or any equivalent thereof. The one or more machine learning models may be trained using supervised learning, unsupervised learning, back propagation, transfer learning, Adam stochastic optimization, stochastic gradient descent, learning rate decay, dropout, max pooling, batch normalization, long short-term memory, skip-gram, or any equivalent deep learning technique. The one or more machine learning models may be trained, for example, using sensor activation data. The sensor activation data may comprise activation information based on users entering and leaving target areas of the sensors and/or activation of fixtures and appliances. The one or more machine learning models may be trained to identify patterns from the sensor activation information. That is, the one or more machine learning models may perform pattern analysis on the sensor activation information to determine the location of sensors and/or typical usage patterns.

In step 320, the computing device may deploy the one or more trained machine learning models. The one or more machine learning models may be deployed, for example, as part of an activity monitoring system. The activity monitoring system may initially use the one or more trained machine learning models to determine a layout of the enclosed space (e.g., restroom). Additionally or alternatively, the activity monitoring system may initially use the one or more trained machine learning models to identify a location of each of a plurality of sensors located in the enclosed space. After determining the layout of the enclosed space and/or identifying the location of each of the plurality of sensors in the enclosed space, the activity monitoring system may use the one or more machine learning models to determine traffic and activity information associated with the enclosed space. The traffic and activity information may include a number of people in the bathroom, what fixtures and devices are in use, which fixtures need maintenance based on attendance, how many people are waiting to use the fixtures, and the like.

In step 330, the computing device may detect activation of one or more sensors in a first enclosed space (e.g., first restroom 105, second restroom 205). In this regard, as one or more users enter and traverse through the enclosed space, sensors in the vicinity of each user may be activated when the user comes in range of the sensor and deactivated when the user leaves the sensor range. Additionally, activation of fixtures (e.g., a toilet flush, a urinal flush, water turned on in a faucet, water turning off at a faucet, etc.) may also be trigger a notification to the activity monitoring system. Any activation or deactivation on a sensor or device would be considered a state change. As noted above, observed sequential state changes may indicate that the sensors and/or devices are proximate to each other. Similarly, observed sequential state changes associated with a user may indicate the user’s intent and/or state within the enclosed space.

In step 340, the computing device may determine usage information of the first enclosed space. The usage information may be based on a number of activations detected in the enclosed space. The usage information may be based on a number of activations in a predetermined amount of time. Additionally or alternatively, the usage information may be based on the intent of the users in the enclosed space. T he usage information may indicate peak usage times, average usage length, hygiene practices of average users, etc. The usage information may include statistics about a restroom’s usage and/or critical diagnostics. Additionally or alternatively, the usage information may include information about individual fixtures, including, for example, real-time information about whether a fixture is currently being used. The usage information may include a start time of a fixture’s use, an end time of the fixture’s use, a duration of the fixture’s use, etc. Information about individual fixtures may also indicate fixtures that are out-of-service or, otherwise, not being used.

In step 350, the computing device may display the usage information. The usage information may be displayed on a display device outside of the restroom as shown, for example, in FIG. 1A. The display may redirect users to other restrooms, for example, based on occupancy and/or based on the operability of one or more fixtures. Additionally or alternatively, the usage information may be displayed via a dashboard that is accessible by one or more user devices. The dashboard may provide an overall view of the plumbing of a building, as well as granular data and/or information for individual fixtures. The dashboard may provide real-time information regarding whether a fixture is currently in use and/or notifications, such as whether a restroom and/or fixture requires attention. In addition to displaying usage information, the computing device may provide recommendations regarding maintenance and/or cleaning of the bathroom itself. In particular, information about fixtures that are out-of-service or, otherwise, not being used may prompt notification and/or maintenance. For example, if a user begins using a first fixture and quickly moves to a second fixture, the computing device may determine that the first fixture is not in working order. The computing device may send (e.g., transmit) an electronic communication (e.g., text, email, push notification, etc.) to a user device and/or dashboard to notify that a fixture is not being used and may require service and/or maintenance. In some instances, the usage information may trigger one or more events. For example, the computing device may cause a scent to be dispensed by an air freshener, for example, based on a determination that a restroom is unoccupied. Alternatively, the computing device may cause a scent to be dispensed by an air freshener, for example, based on a determination that the restroom is expected to be occupied in the immediate future.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although certain specific aspects of various example embodiments have been described, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. Thus, embodiments disclosed should be considered in all respects as examples and not restrictive. Accordingly, the scope of the inventions herein should be determined not by the embodiments illustrated, but by the appended claims and their equivalents.

1. A system comprising:
a plurality of sensors, wherein a subset of the plurality of sensors are situated above ceiling tiles;
one or more processors; and
memory storing instructions that, when executed by the one or more processors, cause the system to:
detect activation of a first sensor of the plurality of sensors;
detect, after activation of the first sensor, activation of a second sensor of the plurality of sensors;
determine, based on activation of the first sensor and based on activation of the second sensor, a layout of an enclosed space;
determine, based on activation of one or more sensors of the plurality of sensors, usage information of the enclosed space; and
cause the usage information to be displayed.

2. The system of claim 1, wherein the instructions, when executed by the one or more processors, cause the system to:
determine, based on activation of a second subset of sensors in a sequential order, a usage pattern associated with the enclosed space.

3. The system of claim 1, wherein the plurality of sensors form a self-organizing mesh network.

4. The system of claim 3, wherein:
the plurality of sensors comprises a second subset of appliance-based sensors; and
the self-organizing mesh network further comprises the second subset of appliance-based sensors.

5. The system of claim 3, wherein the self-organizing mesh network comprises one or more devices.

6. The system of claim 5, wherein the one or more devices comprises a plumbing fixture.

7. The system of claim 1, wherein a first sensor, of the subset, comprises a radar sensor.

8. The system of claim 1, wherein instructions, when executed by the one or more processors, cause the system to determine one or more of:
the layout of the enclosed space using a machine learning model; or
the usage information using a machine learning model.

9. The system of claim 1, wherein a second subset of the plurality of sensors are associated with a respective plumbing fixture.

10. The system of claim 1, wherein instructions, when executed by the one or more processors, cause the system to determine, based on the usage information, an issue with a fixture in a restroom.

11. The system of claim 1, wherein instructions, when executed by the one or more processors, cause the system to display the usage information via one or more of:
a dashboard; or
a display located outside of the enclosed space.

12. A computer-implemented method comprising:
detecting, by a computing device, activation of a first sensor of a plurality of sensors, wherein a subset of the plurality of sensors are situated above ceiling tiles of an enclosed space;
detecting, by the computing device and after activation of the first sensor, activation of a second sensor of the plurality of sensors;
determining, by the computing device and based on activation of the first sensor and based on activation of the second sensor, a layout of the enclosed space;
determining, by the computing device and based on activation of one or more sensors of the plurality of sensors, usage information of the enclosed space; and
causing, by the computing device, the usage information to be displayed.

13. The computer-implemented method of claim 12, further comprising:
determining, by the computing device and based on activation of a second subset of sensors in a sequential order, a usage pattern associated with the enclosed space.

14. The computer-implemented method of claim 12, wherein the plurality of sensors form a self-organizing mesh network.

15. The computer-implemented method of claim 12, wherein the determining the layout of the enclosed space using a machine learning model.

16. The computer-implemented method of claim 12, wherein the determining the usage information using a machine learning model.

17. The computer-implemented method of claim 12, further comprising:
determining, based on the usage information, an issue with a fixture in a restroom.

18. The computer-implemented method of claim 17, further comprising:
sending, by the computing device, a notification of the issue with the fixture.

19. The computer-implemented method of claim 12, wherein the usage information is displayed via one or more of:
a dashboard; or
a display located outside of the enclosed space.

20. The computer-implemented method of claim 12, further comprising:
causing, by the computing device and based on the usage information, redirection information to be displayed via one or more displays.
